(19) United States
(12) Patent Application Publication
(10) Pub. No.: US 2014/0175941 A1
(43) Pub. Date: Jun. 26, 2014

(54) VARIABLE CAPACITIVE ELECTROSTATIC MACHINERY WITH MACRO PRESSURE-GAP PRODUCT

(71) Applicant: Electric Force Motors, LLC, Ashland, VA (US)

(72) Inventor: Weston Clute Johnson, Richmond, VA (US)

(73) Assignee: Electric Force Motors, LLC, Ashland, VA (US)

(21) Appl. No.: 14/138,004

(22) Filed: Dec. 20, 2013

Related U.S. Application Data
(60) Provisional application No. 61/740,269, filed on Dec. 20, 2012.

(51) Int. Cl. H02N 1/00

(52) U.S. Cl. CPC H02N 1/002
USPC 310/309

(57) ABSTRACT

An operational electrostatic machine having a gap distance and a gap medium pressure product above 100 μm*atm, outside enclosure housing dimensions having a height, a length and a width, that are each greater than one hundred times (100×) the product of the gap distance and the gap medium pressure, one or more electrically isolated conductive layers that, during operation, facilitate storage of electric charge, and an electric field created by the stored charge of a particular polarity passes through surrounding insulative layers, making a path to couple to an electric field of a stored charge of opposite polarity on a contiguous plate, and where, during operation, unaligned conductive layers that are repetitively charged and discharged using appropriate control techniques facilitate production of useful forces.

### CROSS-REFERENCE TO RELATED APPLICATIONS

This application claims the benefit under 35 U.S.C. §119(e) of U.S. Prov. Pat. App. No. 61/740,269, filed Dec. 20, 2012, and is hereby incorporated by reference in its entirety as if fully set forth below.

### FIELD OF THE INVENTION

The invention relates generally to variable capacitance electrostatic machinery, and more specifically to electrostatic machinery that operates when the product of pressure and gap distance is larger than the primary maxima (i.e. falling on the right side of the primary maxima) as described by a Paschen curve.

### BACKGROUND

Presently, nearly all electromechanical machinery is produced using magnetic-based technology; i.e. magnetic induction motors. This magnetic-based technology was first commercially introduced in the early 1900's and has had nearly one hundred years to develop and mature. For this reason, recent advancements have largely been limited to marginal material and processing improvements.

Useful forces from electromechanical sources can be developed using several mechanisms as are described by the Lorentz force equation of Equation 1:

\vec{F}=q[\vec{E}+v×\vec{B}] (1)

While Equation 1 describes multiple options for generating force, such as ion or corona options, presently the primary commercial mechanism used to create electromechanical forces utilizes the interaction of magnetic fields. In the case of a magnetic-based machine, the electric field (\vec{E}) of the Lorentz equation is negligible to zero.

Magnetic fields are created when charges are in motion. When a charge is in motion it is called current and it has an induced magnetic field associate with it. The vast majority of modern magnetic-based machinery utilizes currents within conductive windings, typically made of copper, to develop and control magnetic fields in a desirable manner. This is accomplished by modulating current flow through the windings to develop an appropriate magnetic field that interacts with itself or another magnetic field, typically from other current carrying windings or permanent magnets, in such a manner as to create a useful force producing interaction.

While modern machinery is almost exclusively magnetic-based, it is possible, as described in the Lorentz equation, to create machinery that generates forces based primarily upon the electric field. This type of machinery can be classified as electrostatic, and has a negligible to zero magnetic (\vec{B}) field. This type of machinery has traditionally been overlooked as an economically viable source of large force for several primary reasons, including (1) limited manufacturing capabilities, (2), limited understanding of field breakdown in the gap medium and (3) poor control capabilities.

To develop electrostatic machines that have physical dimensions and performance parameters (e.g. torque density) similar to comparable magnetic machines typically requires very large voltages to be created and maintained. This has been difficult to achieve without breakdown or spurious charge loss during application particularly within volumes comparable to magnetic machines. Other variable capacitance electrostatic machinery has been created that use “film-like” designs to create deformation waves between electrodes for creating movement or various protuberances on the film to maintain gap clearance. However, these film-like designs have little application to commercial markets as they have low power ratings and lack the structural integrity needed for industry. It would be advantageous to provide a solution that overcomes these limitations, permitting a high force and/or torque density machine to be created and commercialized, making it useful for modern industry. It is one intention of the present invention to provide for such an industrial need.

A conductive material allows ions (e.g. electrons) to move with relative ease, whereas an insulator inhibits their movement. If however, a field of sufficient value is generated, then even an insulator can be forced to conduct. For example, air is typically considered a fair insulator, but if its breakdown strength, or dielectric strength, of 30 kV/cm is exceeded, then air can breakdown and begin to conduct.

FIG. diagrams a simple electrostatic system 100 having a voltage source 101 to supply charge and conductive bodies 102, 103 that are electrically isolated from one another and separated by a gap. In FIG. 1, a power source 101 applies a voltage and charge to stationary conductive bodies 102 and 103 with a medium 104 between the two bodies. In this system, as the applied voltage is increased, charge builds on the conductive bodies 102, 103 and as the charge builds an electric field is created. If the electric field in the surrounding medium exceeds the dielectric strength of the surrounding medium 104, then it will breakdown and conduct. A power source 101 applies a voltage and charge to stationary conductive bodies 102 and 103 with a medium 104 between the two bodies.

The Paschen curve is a plot of the breakdown voltage for a gap medium versus the product of gap distance d and gap medium pressure p for a nominal temperature. The term “pressure” as used herein refers to the pressure of the gap medium, which could be gas or liquid. FIG. 2 shows an exemplary, or generalized, Paschen curve 201 for a simple electrostatic system as shown in FIG. In FIG. 2, the typically achieved Paschen curve 201 has two main regions, a linear region 202 and indicative of large pressure and gap products and a nonlinear region of the micro pressure gap product region 215. The macro 217 region is inclusive of any plateaus 203 that occur at the transition from 215 to 217. The right side 217 (shaded area) of FIG. 2 shows that for very large products of gap distance and gap medium pressure, breakdown is highly linear 202. In this linear region, breakdown is initiated and dominated by ions in the gap medium. The area below the Paschen curve describes gap distance and gap medium pressure products when the gap medium is primarily non-conductive or insulating. The area above the Paschen curve describes gap distance and gap medium pressure products when the gap medium is primarily conductive.

Although it is common to approximate breakdown as linear, it is not. When products of gap distance and gap medium pressure become sufficiently small, the breakdown becomes non-linear. However, the material and manufacturing techniques necessary to achieve the required gap distance and gap medium pressure products to operate electrostatic machinery in this region have previously been limited and as yet are uneconomical.

The right side 217 (shaded region) of FIG. 2 is termed herein as the “macro pressure gap product region” and will be inclusive of the linear (or nearly linear) 202 region of a Paschen curve. For some systems, a narrow plateau like region 203 may occur, and will be included in the macro pressure gap product region. The left side 215 of FIG. 2 (not shaded) is termed herein as the “micro pressure gap product region” and will be inclusive of the minimum point on the Paschen Curve and is primarily non-linear.

Conventional electrostatic machinery falls primarily into two groups, micro-machinery and macro-machinery.

Micro-machinery, as its name implies, is classified as machinery having outside encapsulating dimensions (height, length and width) typically less than a few hundred micrometers but possibly as large as a few centimeters. These small encapsulating dimensions help to facilitate manufacturing and assembly as all dimensions, gap distance inclusive, are inherently small. As all dimensions are of similar relatively small scale, no individual dimension requires significantly tighter tolerance to be held during manufacturing. However, due to the small dimensions, micro electrostatic machinery has had limited power capability, operating at or below ten watts (10 W) and with relatively low applied voltages, conditions required to assist in preventing breakdown.

Conventional electrostatic machinery that has been classified as macro, i.e., having one or more outside encapsulating dimensions (height, length and width) greater than a few centimeters and rated for more than ten watts (10 W), has operated primarily on the far right side 217 of the Paschen curve. Further, it has been defined as machinery constructed with relatively large gap distance and gap medium pressure products as a means to inhibit breakdown and to work within previously existing manufacturing and material capabilities. Further, it has typically utilized high vacuums as the gap medium as another means to minimize breakdown.

Despite being physically large, power densities for prior macro-electrostatic machinery did not significantly increase, nor appreciably approach that of magnetic machines. To overcome the many limitations of the prior art, an improved variable capacitance electrostatic machine (a.k.a switched capacitance machine) is highly desirable. It is an intention of the present invention to provide for such an industrial need.

### BRIEF SUMMARY OF THE INVENTION

Briefly described, in a preferred form, the present invention comprises an operational electrostatic machine (ESM) having a nominal gap distance and gap medium pressure product above 100 μm*atm, and outside enclosure housing dimensions, height, length and width, that are each greater than one hundred times (>=100×) the product of gap distance and gap medium pressure, and has one or more electrically isolated conductive layer(s) that, during operation, facilitate the storage of electric charge, and the electric field created by the stored charge of a particular polarity passes through surrounding insulative layers, making a path to connect to the electric field of a stored charge of the opposite polarity on a contiguous plate, and where, during operation, unaligned conductive layers that are repetitively charged and discharged using appropriate control techniques facilitate the production of useful forces.

The present ESM can utilize an insulating layer to inhibit breakdown that is formed from an oxide layer on the outer surface of the conductive material, or is a separate insulating layer that has been sprayed on, and/or painted on, and/or applied via spin coating, and/or deposited by particle deposition such as in vapor deposition, and/or deposited by sputtering, e-beam, and/or dip-coating, and/or is otherwise grown or deposited onto a substrate, or is an applied film and is utilized as a conformal layer or nearly conformal layer on the exterior of the conductive surface.

The present ESM also utilizes a medium that has properties to improve permittivity of the gap that fills the gap between stationary and mobile components (e.g. rotor and stator) and is utilized in combination with an insulating layer applied to the conductive surface.

The present ESM also can have a specialized coating on the housing of the device that minimizes electromagnetic interference (EMI).

The present ESM, when operating, can maintain a substantially constant product of gap distance and gap pressure when temperature changes in constituent components occur, and/or mechanical vibrations occur.

The present ESM also can utilize a substrate to support the conductive layers that are substantially made of materials such as glass, ceramic, polymer, and/or composite materials, and can have surface roughness and waviness deformations that are less than three hundred and fifty (350) microns in any dimension.

The present ESM also can have surface features that promote directed electric field patterns, and/or increased leading edge surface length.

The present ESM also can utilize substrate materials that have been treated using a method that improves substrate operational performance, such as strength, wear and vibration mitigation.

The present ESM also can measure the gap distance and modulates the applied voltage in such a way as to minimize the risk of field breakdown in the gap medium, and/or to improve the force produced by the motor.

The present ESM also can utilize specialized features to minimize vibration of the substrate plates.

The present ESM also can employ a control system to minimize current ripple in any phase of the motor, and/or minimize switch voltage stress.

The present ESM also can utilize a modular substrate plate design, and a plug system to permit quick assembly of the motor.

The present ESM also can employ a conductive surface design on each phase and/or pole that produces a substantially sinusoidal output force and/or torque, or produces a substantially rectangular pulse output force and/or torque.

The present ESM also can utilize four or more conductive surfaces per substrate plate, and electrically isolated rotor conduction surfaces.

The present ESM also can utilize components with thermal expansion properties that are equal or nearly equal to the substrate materials, and/or components between substrates to mitigate vibrations.

These and other objects, features and advantages of the present invention will become more apparent upon reading the following specification in conjunction with the accompanying drawing figures.

### BRIEF DESCRIPTION OF THE DRAWINGS

The above descriptions of this invention are more clearly understood when considered with the accompanying drawings and the descriptions following. The drawings are for purposes of illustration only and are not intended to create limitations of the invention. In the drawings, like referenced characters refer to the same parts in the several views.

FIG. 1 illustrates gap distance and medium.

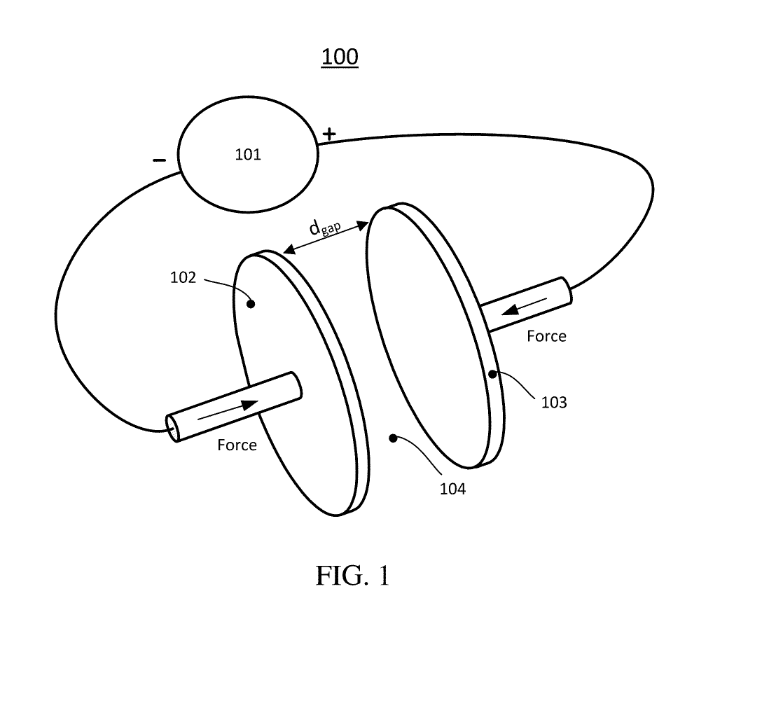

FIG. 2 illustrates a commonly achieved exemplary Paschen curve.

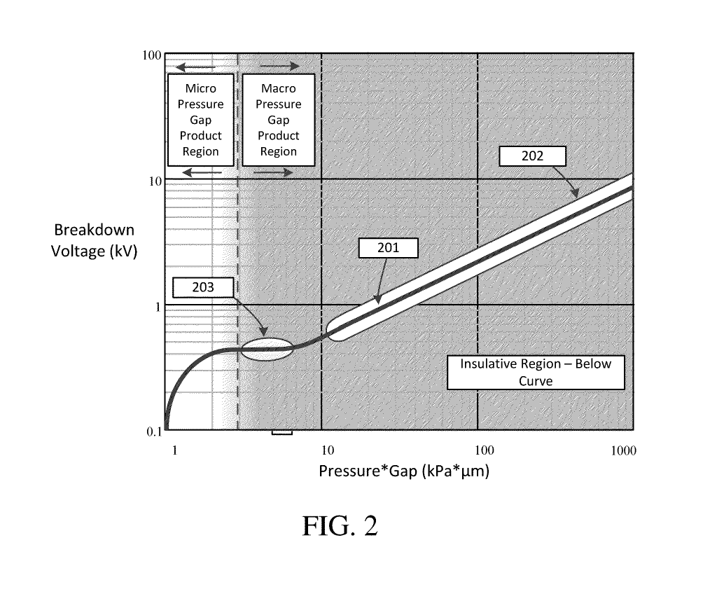

FIG. 3 illustrates an exemplary capacitive motor according to the present invention.

FIG. 4 illustrates an exemplary Paschen curve for the motor of FIG. 3.

FIG. 5 illustrates an exemplary voltage breakdown curve of an electrostatic machine using a coating in accordance with various aspects set forth herein.

FIG. 6 illustrates one embodiment of a capacitive electret system for charge recovery in an electrostatic machine in accordance with various aspects as set forth herein.

FIG. 7 illustrates another embodiment of a capacitive electret system for charge recovery in an electrostatic machine in accordance with various aspects as set forth herein.

FIG. 8 illustrates one embodiment of a control system topology for charge recovery in an electrostatic machine in accordance with various aspects as set forth herein.

FIG. 9 illustrates another embodiment of a control system topology for charge recovery in an electrostatic machine in accordance with various aspects as set forth herein.

FIG. 10 illustrates a perspective view of one embodiment of an electrostatic machine in accordance with various aspects as set forth herein.

FIG. 11 illustrates a side view of another embodiment of an electrostatic machine in accordance with various aspects as set forth herein.

FIG. 12 illustrates an exploded perspective view of another embodiment of an electrostatic machine in accordance with various aspects as set forth herein.

FIG. 13 illustrates an exploded side view of another embodiment of an electrostatic machine in accordance with various aspects as set forth herein.

FIG. 14 illustrates a perspective view of one embodiment of a stator member assembly in accordance with various aspects as set forth herein.

FIG. 15 illustrates an exploded perspective view of one embodiment of a stator member assembly in accordance with various aspects as set forth herein.

FIG. 16 illustrates a perspective view of a portion of one embodiment of a stator member in accordance with various aspects as set forth herein.

FIG. 17 illustrates a perspective view of one embodiment of a rotor member in accordance with various aspects as set forth herein.

FIG. 18 illustrates a perspective view of a portion of one embodiment of a rotor member in accordance with various aspects as set forth herein.

FIG. 19 illustrates a perspective view of one embodiment of a spacer member in accordance with various aspects as set forth herein.

FIG. 20 illustrates a perspective view of one embodiment of a stator modular connector assembly in accordance with various aspects as set forth herein.

FIG. 21 illustrates an exploded perspective view of another embodiment of a stator modular connector assembly in accordance with various aspects as set forth herein.

### DETAILED DESCRIPTION OF THE PREFERRED EMBODIMENTS

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The present invention relates to the field of electro-mechanical machinery, but is patentably distinct because it has minimal or zero magnetic field, and instead utilizes the electric field (i.e. electrostatic machinery) to produce forces.

Modern electrostatic technology is primarily classified as micro-machinery, and may be defined by three main characteristics:

(1) its micro gap distance (which refers to the minimum distance between a mobile force producing surface and a complementary stationary force producing surface, e.g. rotor and stator) and gap pressure products;

(2) small exterior frame dimensions; and

(3) relatively low power.

In patentable contrast, an exemplary embodiment of the present invention has (1) a comparatively macro gap distance and pressure product, (2) exterior frame dimensions that are at least one hundred times greater than the product of pressure and gap distance, (3) rated for 10 W or greater, (4) dielectric coatings on appropriate conductor surfaces, (5) a high permittivity medium in the gap and (6) efficiency greater than eighty-eight percent (88%). As a result, the present invention has wide practical application, placing its commercial utility on par or superior to modern magnetic machinery.

The novel and nonobvious features of the device described herein are achieved using specialized coatings and/or components and/or environmental conditions that permit manageable breakdown and efficient transmission of the electric field to occur, achieving efficient machine operation previously not achievable due to technological limitations. These features permit electrostatic machines to achieve performance densities (e.g. force density, power density, torque density) that are similar or better than modern magnetic machines. The density of the structural materials and components of electrostatic machine tend to be lower than that of magnetic machines which additionally helps to promote high performance densities. Further, the electrostatic machine utilizes high voltages rather than high currents to produce forces and torques. This feature inherently lowers the heating or I²R losses of the electrostatic machine, which tends to be the primary source of inefficiency in modern magnetic machinery.

The present invention preferably comprises switched or variable capacitance electrostatic machinery. This means that the machine produces force and/or torques in direct relation to the variation of capacitance within the machine. The present invention may be synchronous or asynchronous. The present invention utilizes controls to modulate applied voltages between electrically isolated plates to distribute charge in such a manner as to create force that is economically feasible. This force is generated by the inherent electric fields of the charges, which is also known as Coulombic force.

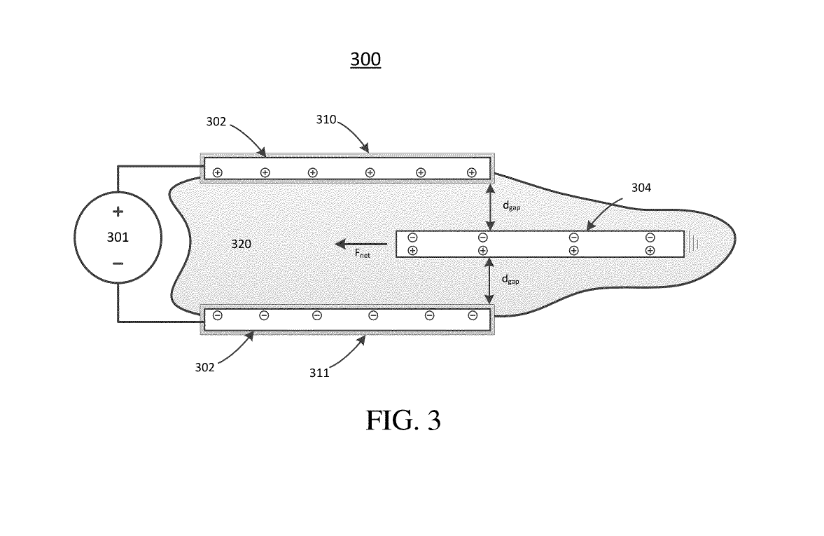

When a switched or variable capacitance machine is in operation, charge is discretely placed on the stationary conductor(s) (e.g. stator poles), which is achieved by modulating applied stationary conductor voltages. This charge on the stationary conductor has an inherent electric field that extends to adjacent mobile conductor(s) (e.g. rotor poles) which, in turn, causes charges on the mobile conductor to redistribute. The redistributed rotor charges remain in place so long as the electric field from the stationary conductor(s) exists and so long as they remain electrically isolated. For clarity, an illustrative diagram of a capacitive motor is shown in FIG. 3. FIG. 3 shows a power source 301 that applies a voltage and charge to stationary conductive bodies 302 and 303. These conductive bodies have an insulating coating 310 and 311 that minimize breakdown between conductive components. Positioned between 302 and 303 is a conductive mobile body 304. In the gap between the conductive mobile bodies 302, 303 and 304 is a high permittivity medium 320.

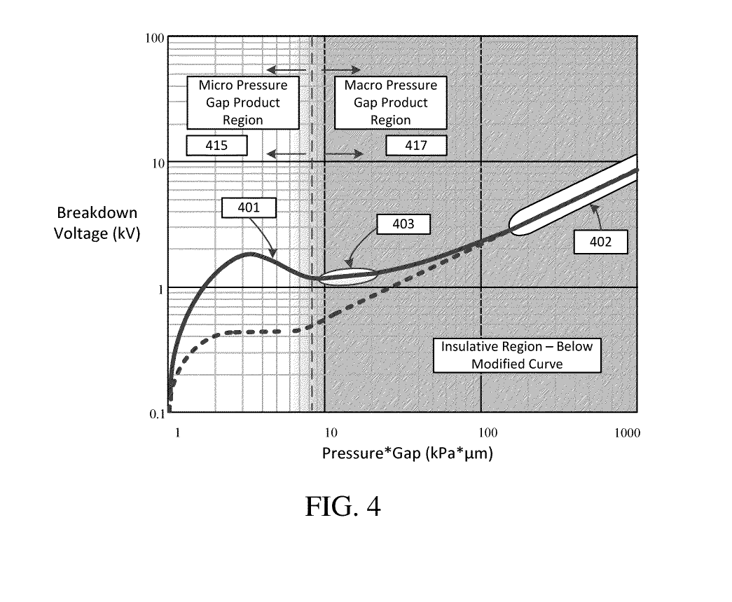

Further, the present invention utilizes high dielectric strength coatings, applied to one or more portions of conductive bodies in the system, to advantageously alter the breakdown characteristics of the system. These coatings may have dielectric strengths at or above 200V/μm. FIG. 4 shows an exemplary Paschen curve for achieving this improved breakdown outcome, with typical altered traits. In addition to high dielectric strengths, these coatings may also have a relative permittivity of at least ten (10). In conjunction with the dielectric coatings, the present invention also uses a gap medium that has beneficial dielectric strength and/or permittivity properties so as to permit improved conduction of the electric fields across the gap. This gap medium may have a relative permittivity of at least twenty (20). In addition to this high permittivity, the gap medium may also have a dielectric strength of at least 3V/μm. Together, the utilization of a dielectric coating and gap medium with beneficial permittivity permits an electrostatic switched or variable capacitance electrostatic machine to operate with altered breakdown characteristics and sufficiently improved field transfer efficiency, so as to permit macro gaps in an electrostatic machine which lowers manufacturing costs that may make the electrostatic machine economically advantageous. Utilizing coatings with high dielectric strength permits a typical Paschen curve 410 to be altered to curve 401. In altering the curve 410, the linear region 402 is shortened and any plateau regions 403 are elevated and enlarged. This altered Paschen curve affects both the micro pressure gap product region 415 and the macro pressure gap product region 417.

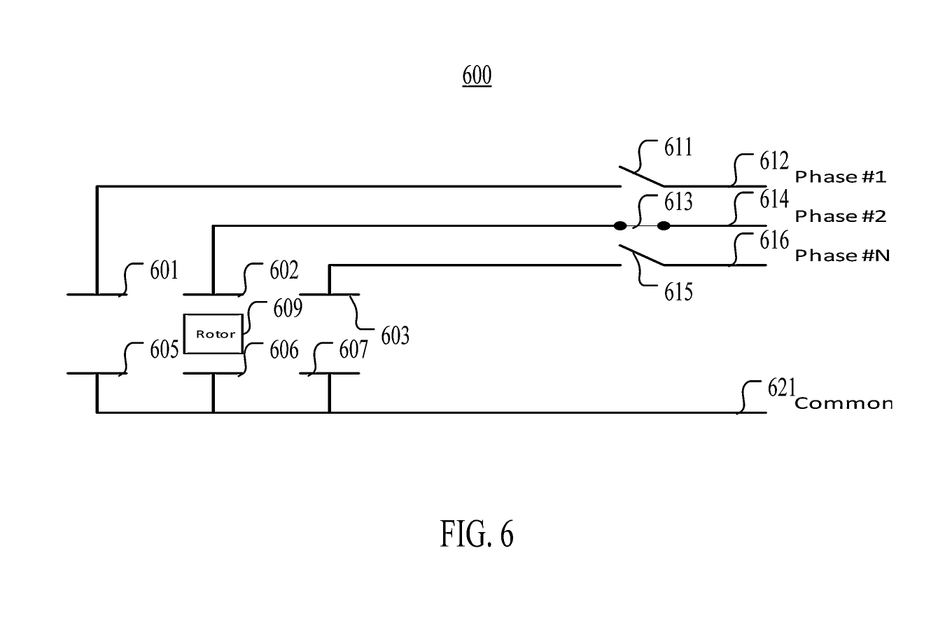

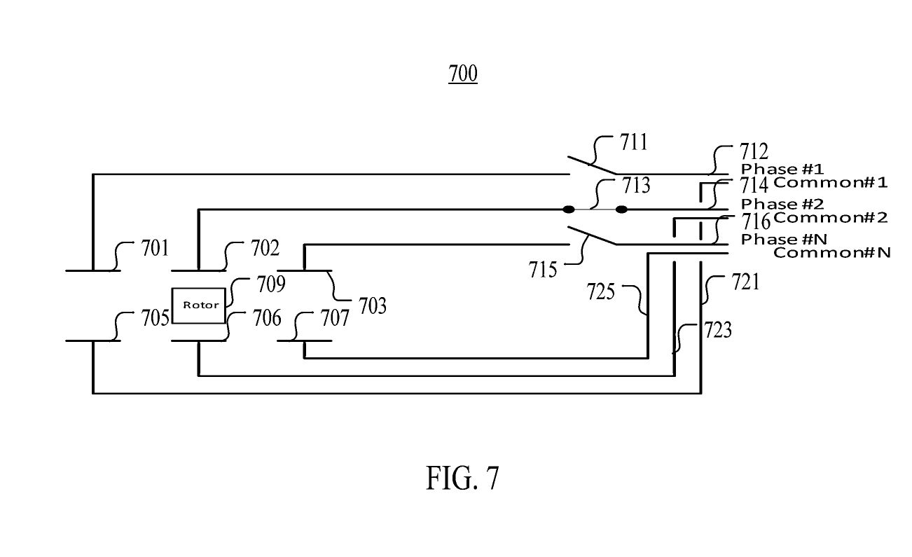

The present invention can operate with multiple phases, each having a multitude of poles. The common or return path for the phases may be connected with either a single connection, or independent connections as shown in FIG. 6 and FIG. 7, respectively.

Because the external electric field is created by static charges (i.e. charges not in motion), several beneficial features of the present invention are not found in conventional magnetic machines.

One, because the charge is static, the voltage supply can be disconnected from the motor without destroying the placed charge (unless dissipated by some other mechanism), thus permitting charge and forces to remain after the voltage source is disconnected. This is analogous to an electrolytic capacitor remaining charged after being disconnected from its voltage source. This fixed charge, having an electric field and Columbic force, is a problem unique to electrostatic motors, in that common induction magnetic motors utilize magnetic fields generated by currents which are naturally extinguished when the current supply is disconnected.

Thus, for continuous operation, electrostatic motors must continuously add charge to certain stationary conductive body(s) while removing charge on others. To achieve improved efficiencies, previously positioned charge can be recovered and repositioned. This operation and control technique, called “charge recycling,” which is the recycling of charge throughout a motor's operating and control sequence, is unique to the specific type of device disclosed herein.

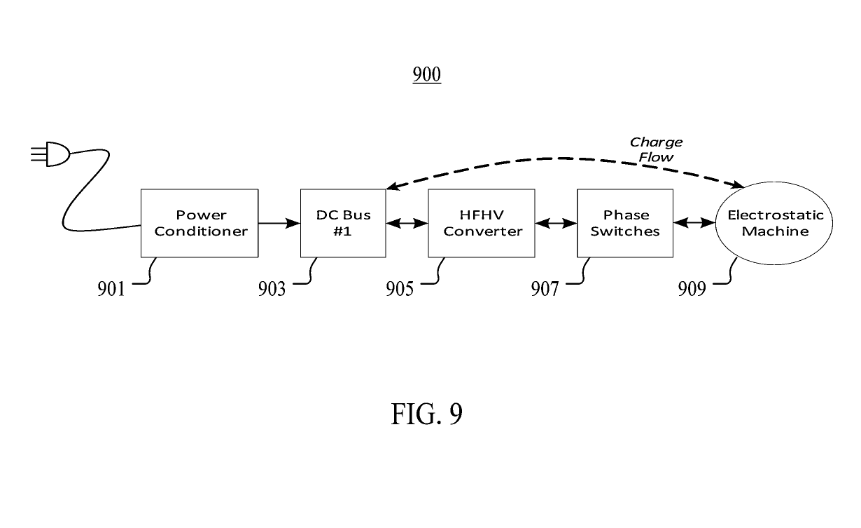

Error! Reference source not found. diagrams a DC method that can be employed to achieve charge recycling and control for the present invention. In this figure, voltage converters are used to step between various DC bus voltage levels and phase switches are used to connect various buses to the electrostatic machine. Utilizing a large voltage drop between the charged stationary conductor(s) of the ESM and a bus with lower voltage that is connected in parallel to the charged stationary conductor(s) is a control method employed in the present invention to accomplish charge recycling in a DC system. In the case of an AC method, shown in FIG. 9, charge recycling may be accomplished by switching at the zero crossing.

Numerous methods exist to develop useful voltages and currents. State-of-the-art induction motor controls utilize magnetic-based components, such as an inductor in a boost converter or a transformer, etc., to develop the required voltages and currents.

Typically, induction-based machines operate with relatively low voltage and high current. But unlike induction-based machines, electrostatic machines require relatively low currents and high voltages. This allows switched capacitor and/or voltage multiplier techniques to now be an option for use independently or in combination with other traditional magnetic techniques to develop the voltages required by electrostatic machines. Utilizing capacitor-based voltage control techniques allows for lighter and potentially smaller volume assemblies.

Because most modern electromechanical machinery is magnetic-based (a current driven technology), modern solid state technology with high voltage ratings tend to also have relatively high power ratings, and this combination tends to be economically costly. An economical alternative provided by electrostatic machines that are voltage driven is to use series combinations of low current rated solid state switches in such a manner that (1) the rated voltage of each device is not exceeded, and (2) the combined voltage ratings of the series connected switches exceeds the applied voltage.

The ease of manufacturing electrostatic machinery is enhanced when the following conditions exist: low cost materials, standard manufacturing techniques and low tolerances. These conditions are supported when an electrostatic machine is operating on the right side of the Paschen curve while also achieving high electric field transfer efficiency. High field transfer efficiency is beneficial in achieving operation from relatively low applied voltages while also having relatively large gap distances.

An exemplary embodiment of the present invention incorporates one or more of the following characteristics:

large electrostatic machinery, defined as machinery with overall dimensions (height, length, width) that are significantly larger (>=100×) than the product of the gap distance and pressure of the gap medium;

a switched or variable capacitance topology which is inclusive of designs with electrets;

utilizing coatings with dielectric strength equal to or above 200V/μm to modify the breakdown pattern of an embodiment of the disclosed; or

utilizing a fluid as the medium between the constituent stationary and mobile conductive components having a relative permittivity of 20 or more.

The present invention may use dielectric coatings, such as but not limited to, electroactive polymers, parylenes, oxides and polymers with fluorine. Also, the present invention may utilize gap medium materials with appropriate dielectric strength or high permittivity to improve performance, such as but not limited to, deionized water and hexafluoride gas. Conductive and insulative coatings may be used independently; gap medium materials that improve permittivity or other properties may be used independently; and these coatings and gap medium materials may be used in combination.

Three means of increasing the force of the electrostatic machine including adding addition rotor plates, increasing the number of poles per phase, and increasing the applied voltage in an appropriate manner.

In an exemplary embodiment, the present invention utilizes one or more substrate plates having one or more conductive layers on one or more surfaces (without dielectric coatings). These plates are then held in aligned position by appropriate retaining parts, such as rods and tensioning mechanisms, so that a small gap distance exists between each of them. This series of plates is then immersed in a liquid or gas medium that has desirable properties, such as inhibiting breakdown or improving permittivity, and this medium fills the gap space between the plates.

In another exemplary embodiment, the present invention utilizes one or more substrate plates having one or more conductive layers on one or more surfaces which have been encapsulated by one or more dielectric coatings. These plates are then held in aligned position by appropriate retaining parts, such as rods and tensioning mechanisms, so that a small gap distance exists between each of them. This series of plates is then immersed in a liquid or gas medium that has desirable properties, such as inhibiting breakdown or improving permittivity, and this medium fills the gap space between the plates.

In another exemplary embodiment, the present invention combines the electrostatic machine and appropriate controls into a unified assembly, constituting a single structure. It is envisioned that a housing component will be utilized to encapsulate all components for utility, cleanliness, safety and aesthetic purposes. Further, it is envisioned that this housing component can be designed to be removable so that major components, such as the controls and/or electrostatic machine, can be replaced.

Novel and nonobvious features of the above-described embodiments include, among others, the utilization of specialized patterning of the conductive layers on one or more of the substrate plates to produce a highly sinusoidal or rectangular force profile when the electrostatic machine is in normal operation, the utilization of software algorithms or other control schemes to minimize the voltage and/or current stress on the switches when the electrostatic machine is in normal operation, and the utilization of software algorithms or other control schemes that cause the applied voltages to produce a highly sinusoidal and/or rectangular force profile when the electrostatic machine is in normal operation.

The present invention can include, among other embodiments, electrostatic motors—operating in synchronous, asynchronous and/or step modes, including linear motor operation, electrostatic solenoids (actuators), electrostatic vibrators, and electrostatic generators. While described and shown as primarily as a rotational motor, the present invention includes other embodiments, such as linear motors, generators, solenoids, actuators, vibrators, etc.

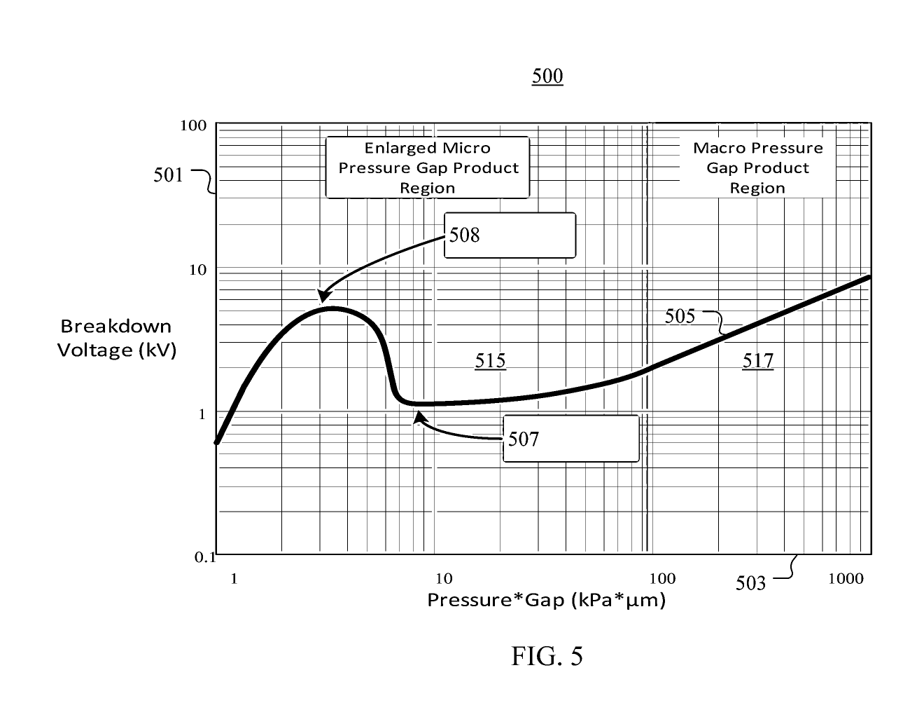

FIG. 5 illustrates an exemplary voltage breakdown curve 505 of an electrostatic machine using a coating in accordance with various aspects described herein. The breakdown voltage from one-tenth of a kilovolt (0.1 kV) to one hundred kilovolts (100 kV) is plotted on the abscissa 501. Further, the product of a gap pressure (p_{gap}) and a gap distance (d_{gap}) from one kilopascals-micrometer (1 kPa*um) to one thousand kilopascals-micrometer (1,000 kPa*um) is plotted on the ordinate 503. A first region 515 of the curve 505 may be referred to as the micro-pressure gap product region. Further, a second region 517 of the curve 505 may be referred to as the macro-pressure gap product region. FIG. 5 shows a first operating point for the electrostatic machine using the coating to create a localized maxima 508. Further, FIG. 5 shows a second operating point for the electrostatic machine using the coating near an elevated localized minima 507. The elevated localized minima 507 may be part of a plateau region.

It may be desirable to operate electrostatic machinery with a maximum electric field and electric field force density that has been obtained with a minimal applied voltage. This electric field relationship is shown in Equation 2 below, where V is the source voltage, d_{gap} is the gap distance between electrode bodies, and \vec{E} is the resulting electric field of the gap.

$${E}^{->} = - ∇ V ≅ - \frac{V}{{d}_{gap}} , \qquad ( 2 )$$

In one embodiment, an electrostatic machine may be configured to utilize a dielectric coating on a stator member, a rotor member, or both. The dielectric coating, which may also be referred to as a dielectric layer, may be used to alter the voltage breakdown curve. In one example, the dielectric coating may be a parylene or a fluorine. The use of the dielectric coating by the electrostatic machine may allow for changing the shape of the voltage breakdown curve such as shifting the curve in any direction or inducing a plateau area in the voltage breakdown curve, as illustrated in FIG. 5. The plateau area in FIG. 5 may allow for increased electric field densities.

In another embodiment, an electrostatic machine may use one or more plates with appropriately applied conductive areas to increase the total area of electric force producing surfaces.

An electrostatic machine may be described as a micro-electrostatic machine or a macro-electrostatic machine. In one definition, the micro-electrostatic machine may be an electrostatic machine having outside encapsulating dimensions of a height, a length and a width with each dimension less than or equal to a few hundred micrometers. In another definition, the micro-electrostatic machine may be an electrostatic machine having outside encapsulating dimensions of a height, a length and a width with each less than or equal to ten millimeters. These small encapsulating dimensions may facilitate operation on the first region of the Paschen curve, such as described in FIG. 4, as all dimensions, including gap distance, are inherently small. As all dimensions may be of similar relative scale, an individual dimension may not require a tighter tolerance during manufacturing or operation. However, due to the smaller dimensions, a micro-electrostatic machine may have a limited power capability. In one example, a micro-electrostatic machine may operate at or below ten watts (10 W). Further, a micro-electrostatic machine may require lower voltages to avoid voltage breakdown.

In one definition, the macro-electrostatic machine may be an electrostatic machine having outside encapsulating dimensions of a height, a length and a width with each dimension greater than a few hundred micrometers. In another definition, the micro-electrostatic machine may be an electrostatic machine having outside encapsulating dimensions of a height, a length and a width with each greater than ten millimeters. In another definition, the micro-electrostatic machine may be an electrostatic machine having outside encapsulating dimensions of a height, a length and a width with each greater than one hundred millimeters. These small encapsulating dimensions may facilitate operation on the second region of the Paschen curve, as described in FIG. 4, as all dimensions, including gap distance, are inherently small. Prior art electrostatic machinery that are classified as a macro-electrostatic machine operate in the macro pressure gap product region of the Paschen curve and have primarily utilized electrostatic induction and charge transfer techniques to operate. Despite being physically large, prior art electrostatic machinery could not achieve electric field force densities on par with comparably sized magnetic field based machines. Additionally, the generation and control of voltages sufficient to produce commercially viable electric forces were difficult to achieve with prior art manufacturing and material capabilities. For these reasons, prior art macro-electrostatic machines failed to be economically viable compared to comparably-sized magnetic induction machines.

In another embodiment, an electrostatic machine may be a non-commutated capacitive electret, which may be a switched capacitance electrostatic machine or a variable capacitance electrostatic machine.

In another embodiment, an electrostatic machine may be synchronous or asynchronous.

In another embodiment, an electrostatic machine may modulate applied voltages between a plurality of electrically isolated poles to distribute charge, producing useful forces.

In another embodiment, an electrostatic machine may include an electric field motor having a plurality of stator members. Each of the plurality of stator members may include a plurality of electrically conductive poles. Further, the plurality of electrically conductive poles of each of the plurality of stator members may form a plurality of electrically isolated poles with each of the plurality of electrically isolated poles coupled to a different phase of a voltage source.

The electrostatic machine may modulate applied voltages between a plurality of electrically isolated poles to distribute charge, producing useful forces. FIG. 6 illustrates one embodiment of a system 600 for charge recovery in an electrostatic machine in accordance with various aspects as set forth herein. In FIG. 6, the system 600 may be configured to include a rotor member 609 having a plurality of electrically isolated conductive poles, a first stator member having a plurality of electrically conductive poles 601, 602 and 603, a second stator member having a plurality of electrically conductive poles 605, 606 and 607, a plurality of switches 611, 613 and 615, a plurality of phase voltages 612, 614 and 616, and an electrical common 621. One of a plurality of electrically isolated conductive poles of a rotor member may also be referred to as a rotor pole. Similarly, one of a plurality of electrically conductive poles of a stator member may also be referred to as a stator pole. In one example the number of rotor and stator poles are not equal. In one example, the electrostatic machine may be a three-phase, capacitive electret electrostatic machine, which may also be referred to as a switched-capacitor electrostatic machine or variable capacitance electrostatic machine. The rotor member may be electrically isolated. The system 600 may be configured to perform charge recovery by recycling electric charge throughout an operating sequence of the electrostatic machine. Further, charge recycling may be unique to electrostatic machines.

In operation, a charge may be placed from one of the plurality of phase voltages 612, 614 and 616 onto one of the plurality of electrically conductive poles 601, 602, 603, 605, 606 and 607 of the first stator member when one of the plurality of switches 611, 613 and 615 is closed. The electric field from the charge placed on one of the plurality of electrically conductive poles 601, 602, 603, 605, 606 and 607 of the first and second stator members may induce an electric field on an adjacent rotor pole of the plurality of electrically isolated conductive poles of the rotor member 609. The external electric field from the plurality of stator members may extend to the adjacent rotor pole, in turn, may cause charges to redistribute on the rotor pole. The redistributed charges on the rotor pole may remain in place so long as the external electric field exists.

FIG. 7 illustrates another embodiment of a charge recovery system 700 in an electrostatic machine in accordance with various aspects as set forth herein. In FIG. 7, the charge recovery system 700 may be configured to include a rotor member 709 having a plurality of electrically isolated conductive poles, a first stator member having a plurality of electrically conductive poles 701, 702 and 703, a second stator member having a plurality of electrically conductive poles 705, 706 and 707, a plurality of switches 711, 713 and 715, a plurality of phase voltages 712, 714 and 716, and a plurality of phase commons 721, 723 and 725. One of a plurality of electrically isolated conductive poles of a rotor member may also be referred to as a rotor pole. Similarly, one of a plurality of electrically conductive poles of a stator member may also be referred to as a stator pole. In one example, the electrostatic machine may be a three-phase, switched-capacitor electrostatic machine. The rotor member may be electrically isolated. The system 700 may be configured to perform charge recovery by recycling electric charge throughout an operating sequence of the electrostatic machine. Further, charge recycling may be unique to electrostatic machines.

In operation, a charge may be placed from one of the plurality of phase voltages 712, 714 and 716 onto one of the plurality of electrically conductive poles 701, 702, 703, 705, 706 and 707 of the first stator member when one of the plurality of switches 711, 713 and 715 is closed. The electric field from the charge placed on one of the plurality of electrically conductive poles 701, 702, 703, 705, 706 and 707 of the first and second stator member may induce an electric field on an adjacent rotor pole of the plurality of electrically isolated conductive poles of the rotor member 709. The external electric field from the plurality of stator members may extend to the adjacent rotor pole, in turn, may cause charges to redistribute on the rotor pole. The redistributed charges on the rotor pole may remain in place so long as the external electric field exists.

Since an external electric field may be created by static charges, charges not in motion or in limited motion, an electrostatic machine may have unique features. First, since the charge is static, a voltage source may be disconnected from an electrostatic machine without eliminating the placed charge. Thus, an electromagnetic machine may allow static charges and their associated electric forces to remain after the voltage source is disconnected from the electromagnetic machine. This is analogous to a capacitor remaining charged after being disconnected from its voltage source. Second, the operating mechanism of an electrostatic machine may come from Columbic forces inherent to a charge. Once the static charge is placed, it remains fixed on a stator pole, even if the current source is disconnected. A person of ordinary skill in the art will recognize that static charges may dissipate over time and at certain rates due to factors such as temperature, pressure and humidity. The use of static charges may be unique to electrostatic machines. A common induction motor may utilize magnetic fields generated by currents which are naturally eliminated when a voltage source is disconnected. For continuous operation, an electrostatic machine may continuously reposition charges between a plurality of electrically isolated poles with each of the plurality of electrically isolated poles coupled to one of a plurality of voltage phases of a voltage source, which necessitates the removal of charge and, to achieve higher efficiency, wherein repositioning of the charge must be captured and recovered rather than dissipated. Through this capture and recovery technique, an overall efficiency of an electrostatic motor and its controls may be improved.

Charge recovery may be accomplished using a number of techniques including using a combination of high and low voltage direct current (DC) buses or phase-pulsed alternating current (AC) systems, which may inherently recover charge.

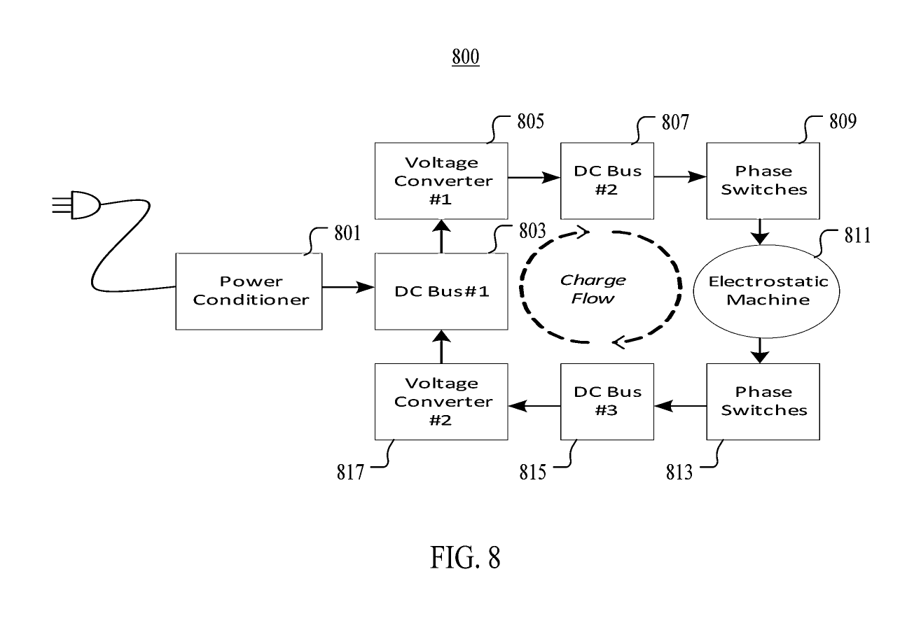

FIG. 8 illustrates one embodiment of a control system topology 800 for charge recovery in an electrostatic machine 811 in accordance with various aspects as set forth herein. In FIG. 8, the topology 800 may be configured to include a power conditioner 801, a first DC bus 803, a first voltage converter 805, a second DC bus 807, a first set of phase switches 809, an electrostatic machine 811, a second set of phase switches 813, a third DC bus 815, and a second voltage converter 817. The power conditioner 801 may be configured to provide DC voltage on the first DC bus 803 from an AC power supply such as a three phase, two hundred and twenty volt (220 V), sixty (60) Hertz line or a battery. In one example, the first DC bus 803 may be a low voltage DC bus. The first voltage converter 805 may be configured to convert the DC voltage on the first DC bus 803 for output on the second DC bus 807. The converted DC voltage on the second DC bus 807 may then be applied to the electrostatic machine 811 using the first set of phase switches 809. The converted DC voltage may be collected from the electrostatic machine 811 onto the third DC bus 815 using the second set of phase switches 813. In one example, the first DC bus 803 may be a low-voltage DC bus, the second DC bus 807 may be a high-voltage DC bus, and the third DC bus 815 may be a low-voltage DC bus. To complete the cycle of charge recovery, the second voltage converter 817 may be configured to recover the collected converted phased DC voltages to their original phased DC voltage form on the first DC bus 803. A charge recovery structure may include portions of the control system topology 800. Further, a motor drive may be configured to include the charge recovery structure. In one example, the charge recovery structure may include the first DC bus 803, the first voltage converter 805, the second DC bus 807, the first set of phase switches 809, the second set of phase switches 813, the third DC bus 815, and the second voltage converter 817. A person of ordinary skill in the art will recognize various forms of charge recovery for electrostatic motors and their associated controls.

In FIG. 8, in operation, a low voltage AC or DC source may be conditioned using the power conditioner 801 to reduce any negative effects on the performance of the electrostatic machine 811 caused by the low voltage AC or DC source. Conditioning of a voltage from the low voltage AC or DC source by the power conditioner 801 may include reducing harmonics and performing power factor correction. The conditioned voltage of the power conditioner 801 may then be output to a low voltage DC bus 803. Energy and charge from the low voltage DC bus 803 may then be converted and transferred using the voltage converter 805 to a high voltage DC bus 807. The high voltage DC bus 807 may then transfer energy and charge through the phase switches 809 to the plurality of voltage phases of an electrostatic machine 811. The high voltage and charge on the plurality of voltage phases of the electrostatic machine 811 may then be transferred through additional phase switches 813 to another low voltage DC bus 815. Energy and charge from the low voltage DC bus 815 may then be converted and transferred using the voltage converter 817 back to the low voltage DC bus 803. The control system topology 800 may produce efficiencies of at least eighty-five percent (85%). Additionally, the charge recycle structure represented by 803, 805, 807, 809, 811, 813, 815, 817 and back to 803 may have efficiencies of at least eighty-five percent (85%).

FIG. 9 illustrates another embodiment of a control system topology 900 for charge recovery in an electrostatic machine in accordance with various aspects as set forth herein. In FIG. 9, the topology 900 may be configured to include a power conditioner 901, a first DC bus 903, a first voltage converter 905, a first set of phase switches 909, and an electrostatic machine 911. The power conditioner 901 may be configured to provide DC voltage on the first DC bus 903 from an AC power supply such as a three phase, two hundred and twenty volt (220 V), sixty (60) Hertz line or a battery. The first voltage converter 905 may be configured to convert the DC voltage on the first DC bus 903 for output to the first set of phase switches 909. In one example, the first voltage converter 905 may be a high frequency high voltage (HFHV) transformer. The converted DC voltage from the first voltage converter 905 may be applied to the electrostatic machine 911 using the first phase switches 909. To complete the cycle of charge recovery, the converted phased DC voltages may be collected from the electrostatic machine 911 onto the first DC bus 903. In one example, the first DC bus 903 may be a low-voltage DC bus. A charge recovery structure may include portions of the control system topology 900. A motor drive may be configured to include the charge recovery structure. In one example, the charge recovery structure may include the first DC bus 903, the first voltage converter 905, and the first set of phase switches 909.

In FIG. 9, in operation, a low voltage AC or DC source may be conditioned using the power conditioner 901 to minimize any negative effects on the performance of the electrostatic machine 911 caused by the low voltage AC or DC source. Conditioning of a voltage from the low voltage AC or DC source by the power conditioner 901 may include reducing harmonics and performing power factor correction. The conditioned voltage of the power conditioner 901 may then be transferred to a low voltage DC bus 903. Energy and charge from the low voltage DC bus 903 may then be transferred using an HFHV converter 905 through phase switches 907 to various phases of an electrostatic machine 909. In one example, the phase switches 907 may be open or close at or near zero crossings of the HFHV converter 905. The control system topology 900 may have efficiencies of at least eighty-five percent (85%). Additionally, the charge recycle structure represented by a processing loop from 903, 905, 907, and 909 may have efficiencies of at least eighty-five percent (85%). A person of ordinary skill in the art will recognize various alternative forms of charge recovery for electrostatic motors and their controls.

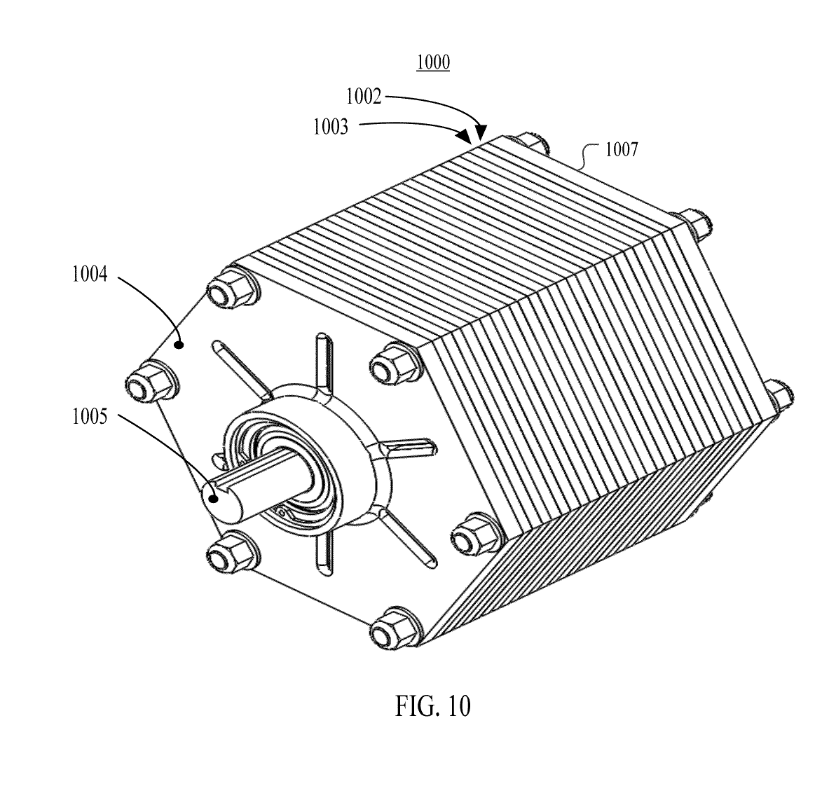

FIG. 10 illustrates a perspective view of one embodiment of an electrostatic machine 1000 in accordance with various aspects as set forth herein. In FIG. 10, the electrostatic machine 1000 may be configured to include a plurality of stator member assemblies 1002, a plurality of stator spacer members 1003, a front encapsulation member 1004, a shaft member 1005, and a back encapsulation member 1007. Further, the electrostatic machine 1000 may be configured to have successive layers of one of the plurality of stator member assemblies 1002 and one of the plurality of stator spacer members 1003 between the front encapsulation member 1004 and the back encapsulation member 1007. In addition, the shaft member 1005 may be positioned in an inner cylindrical volume formed by the plurality of stator member assemblies 1002.

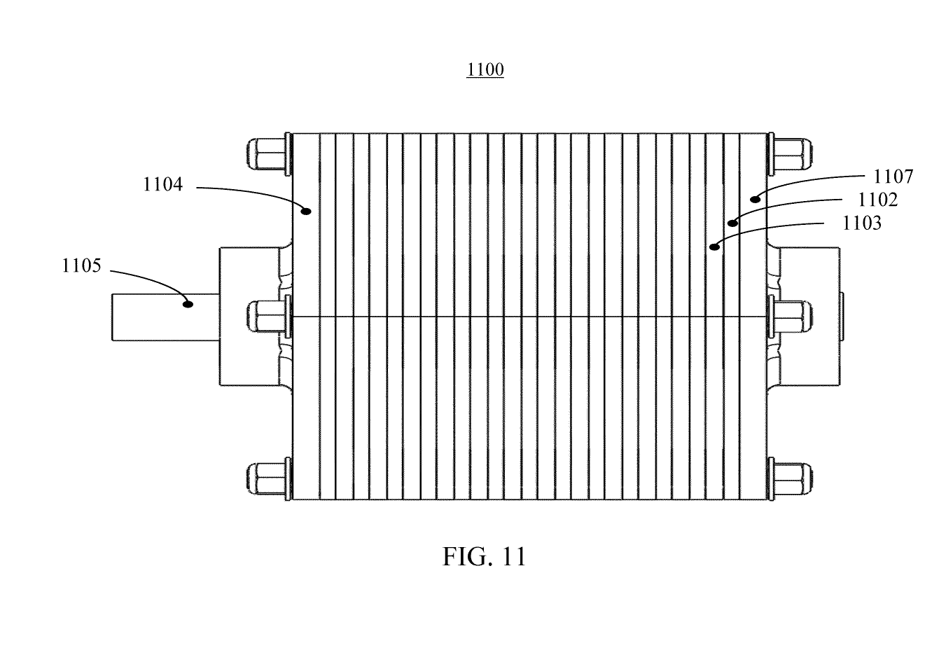

FIG. 11 illustrates a side view of another embodiment of an electrostatic machine 1100 in accordance with various aspects as set forth herein. In FIG. 11, the electrostatic machine 1100 may be configured to include a plurality of stator member assemblies 1102, a plurality of stator spacer members 1103, a front encapsulation member 1104, a shaft member 1105, and a back encapsulation member 1107. Further, the electrostatic machine 1100 may be configured to have successive layers of one of the plurality of stator member assemblies 1102 and one of the plurality of stator spacer members 1103 between the front encapsulation member 1104 and the back encapsulation member 1107. The shaft member 1105 may be positioned in an inner cylindrical volume formed by the plurality of stator member assemblies 1102.

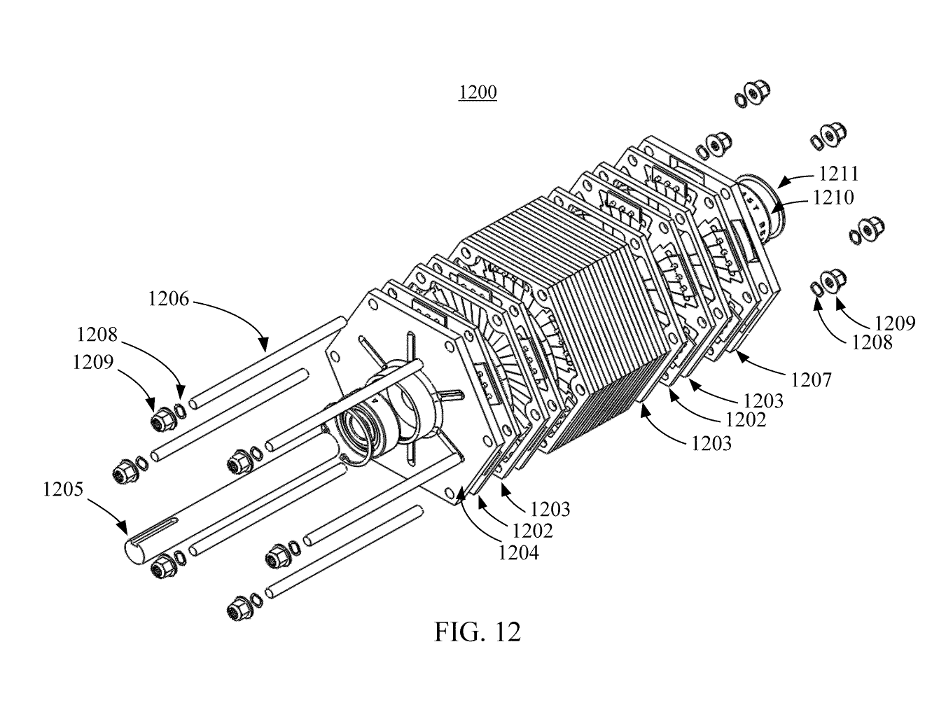

FIG. 12 illustrates an exploded perspective view of another embodiment of an electrostatic machine 1200 in accordance with various aspects as set forth herein. In FIG. 12, the electrostatic machine 1200 may be configured to include a plurality of stator member assemblies 1202, a plurality of stator spacer members 1203, a front encapsulation member 1204, a shaft member 1205, a plurality of alignment rods 1206, a back encapsulation member 1207, a plurality of washers 1208, a plurality of tensioning mechanisms 1209, a plurality of bearings 1210, and a securing ring 1211. Further, the electrostatic machine 1200 may be configured to have successive layers of one of the plurality of stator member assemblies 1202 and one of the plurality of stator spacer members 1203 between the front encapsulation member 1204 and the back encapsulation member 1207. Further, the electrostatic machine 1200 may be configured to have a rotor assembly composed of a rotor members and the shaft member 1205, which may be positioned in an inner cylindrical volume formed by the plurality of stator member assemblies 1202. The plurality of bearings 1210 may be held by the securing ring 1211 to support the shaft member 1205. The plurality of alignment rods 1206 may be used to position the plurality of stator member assemblies 1202 and the plurality of stator spacer members 1203. One of the plurality of washers 1208 and one of the plurality of tensioning mechanisms 1209 may be applied to one or both ends of one of the plurality of alignment rods 1206 to secure the one of the plurality of alignment rods 1206 to the electrostatic machine 1200. In one example, one of the plurality of tensioning mechanisms 1209 may be a fastener such as a nut. In another embodiment, one of the plurality of tensioning mechanisms 1209 may be applied to one or both ends of one of the plurality of alignment rods 1206 to secure the one of the plurality of alignment rods 1206 to the electrostatic machine 1200.

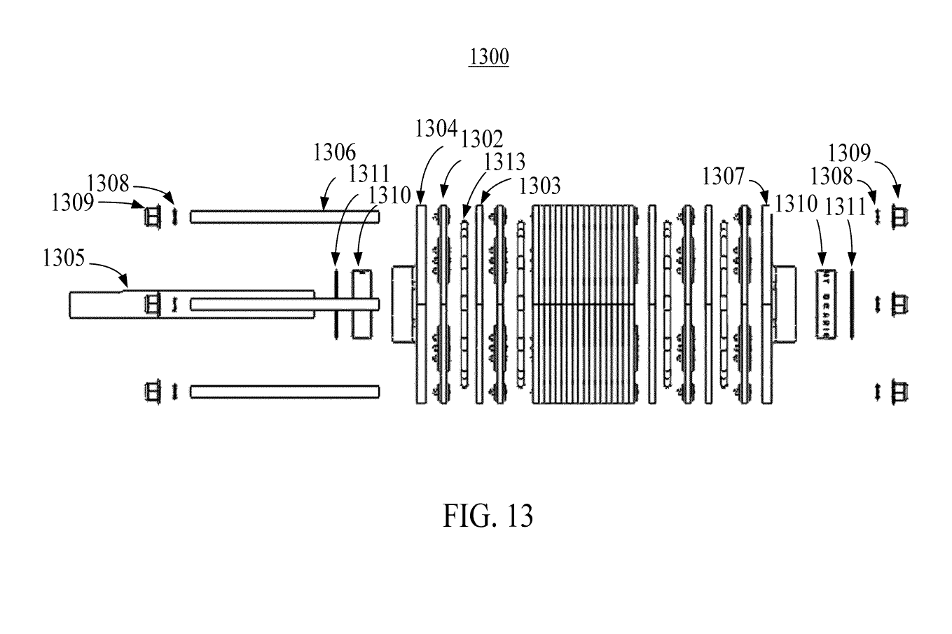

FIG. 13 illustrates an exploded side view of another embodiment of an electrostatic machine 1300 in accordance with various aspects as set forth herein. In FIG. 13, the electrostatic machine 1300 may be configured to include a plurality of stator member assemblies 1302, a plurality of stator spacer members 1303, a front encapsulation member 1304, a shaft member 1305, a plurality of alignment rods 1306, a back encapsulation member 1307, a plurality of washers 1308, a plurality of tensioning mechanisms 1309, a plurality of bearings 1310, a plurality of securing rings 1311, and a plurality of rotor members 1313. Further, the electrostatic machine 1300 may be configured to have successive layers of one of the plurality of stator member assemblies 1302 and one of the plurality of stator spacer members 1303 between the front encapsulation member 1304 and the back encapsulation member 1307 and a rotor assembly. The rotor assembly may be composed of a plurality of rotor members 1313 and shaft member 1305, which may be positioned in an inner cylindrical volume formed by the plurality of stator member assemblies 1302. The plurality of bearings 1310 may be held by the securing ring 1313 to support the shaft member 1305. The plurality of alignment rods 1306 may be used to position the plurality of stator member assemblies 1302 and the plurality of stator spacer members 1303. One of the plurality of washers 1308 and one of the plurality of tensioning mechanisms 1309 may be applied to one or both ends of one of the plurality of alignment rods 1306 to secure the one of the plurality of alignment rods 1306 to the electrostatic machine 1300. In one example, one of the plurality of tensioning mechanisms 1309 may be a fastener such as a nut. In another embodiment, one of the plurality of tensioning mechanisms 1309 may be applied to one or both ends of one of the plurality of alignment rods 1306 to secure the one of the plurality of alignment rods 1306 to the electrostatic machine 1300. Each of the plurality of rotor members 1313 may be positioned in a volume formed between two of the plurality of stator members 1302 that are separated by one of the plurality of stator spacer members 1303.

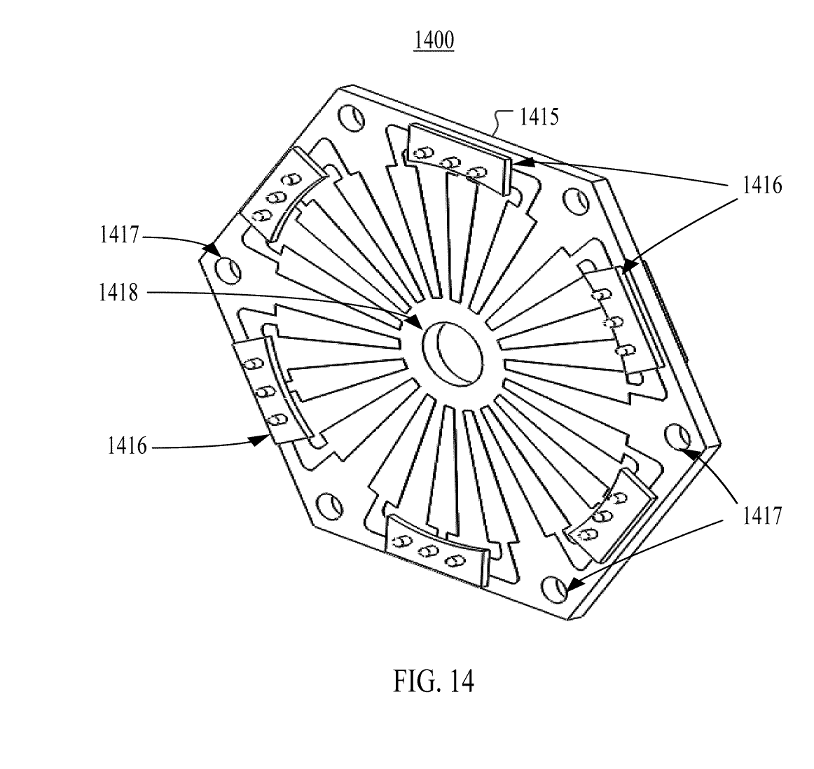

FIG. 14 illustrates a perspective view of one embodiment of a stator member assembly 1400 in accordance with various aspects as set forth herein. In FIG. 14, the stator member assembly 1400 may be configured to include a stator member 1415, a plurality of stator modular connector assemblies 1416, a plurality of alignment rod securing mechanisms 1417, and a shaft cutout 1418. Each of the plurality of alignment rod securing mechanisms 1417 may be a through hole in the stator member 1415 used to allow each of a plurality of alignment rods to align the stator member assembly 1400 with other stator member assemblies. In another embodiment, each of the plurality of alignment rod securing mechanisms 1417 may be used to align and secure the stator member assembly 1400. The shaft cutout 1418 may be a through hole in the stator member 1415 used to allow a shaft member to be freely positioned within the stator member assembly 1400.

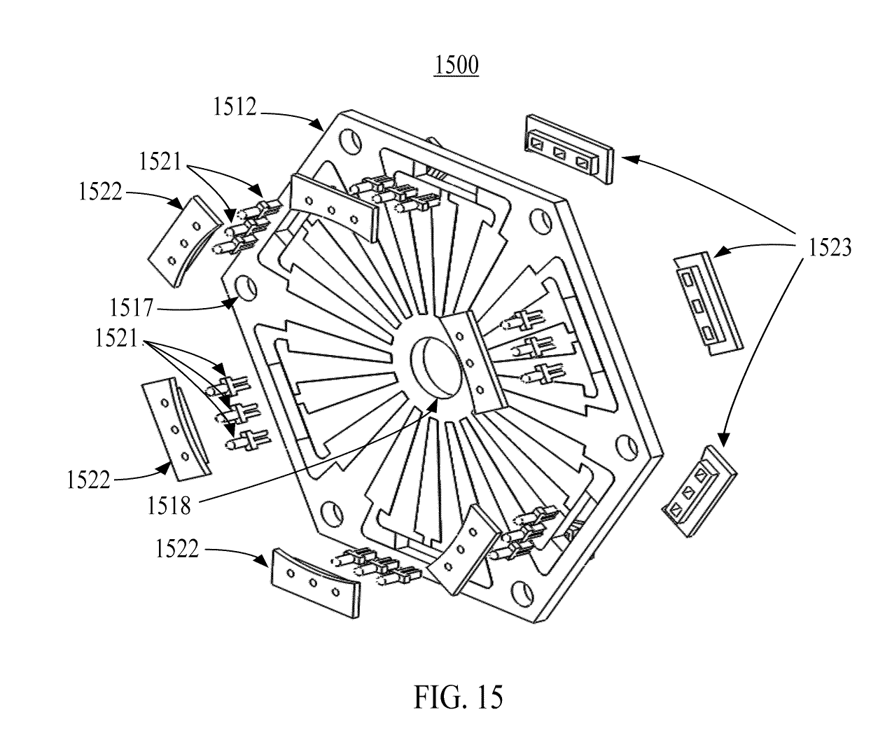

FIG. 15 illustrates an exploded perspective view of one embodiment of a stator member assembly 1500 in accordance with various aspects as set forth herein. In FIG. 15, the stator member assembly 1500 may be configured to include a stator member 1515, a plurality of stator modular connector assemblies, a plurality of alignment rod securing mechanisms 1517, and a stator shaft cutout 1518. Each of the plurality of alignment rod securing mechanisms 1517 may be a through hole in the stator member 1515 used to allow each of a plurality of alignment rods to align the stator member assembly 1500 with a spacer member and another stator member assembly. In another embodiment, each of the plurality of alignment rod securing mechanisms 1517 may be used to align and secure the stator member assembly 1500. The stator shaft cutout 1518 may be a through hole in the stator member 1515 used to allow a shaft member to be freely positioned within the stator member assembly 1500. Each of the plurality of stator modular connector assemblies may be configured to include a stator connector 1521, a stator modular connector front housing 1522, and a stator modular connector back housing 1523. Each of the stator connectors 1521 may be used to couple one of a plurality of stator poles to one of a plurality of voltage phases of a voltage source. In one example, the stator connector 1521 may be a plug or a receptacle.

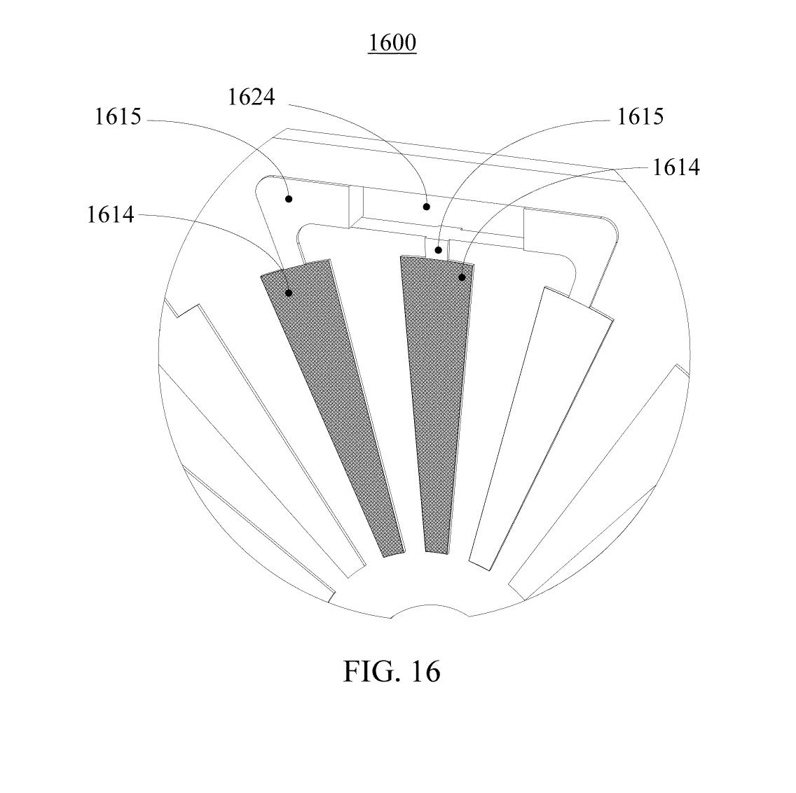

FIG. 16 illustrates a perspective view of a portion of one embodiment of a stator member 1600 in accordance with various aspects as set forth herein. In FIG. 16, the stator member 1600 may be configured to include a plurality of stator poles 1614, a plurality of interconnects 1615, and a slot for a stator modular connector assembly 1624. Each of the plurality of stator poles 1614 may be coupled to the slot for the stator modular connector assembly 1624 using one of the plurality of interconnects 1615. Each of the plurality of stator poles 1614 may be associated with one of a plurality of voltage phases of a voltage source. In FIG. 16, item 1614 is an electrically conductive stator petal 1614 that resides on an electrically insulating substrate 1515. Petals 1614 on a stator member may or may not illustrate the same pole or phase. Petal connector 1615 electrically connects the petal 1614 to an electrical connection location 1624 for an electrical connector to connect to a phase voltage and voltage source. A stator modular connector assembly 2000 may be used to improve assembly features of the electrostatic machine 1000.

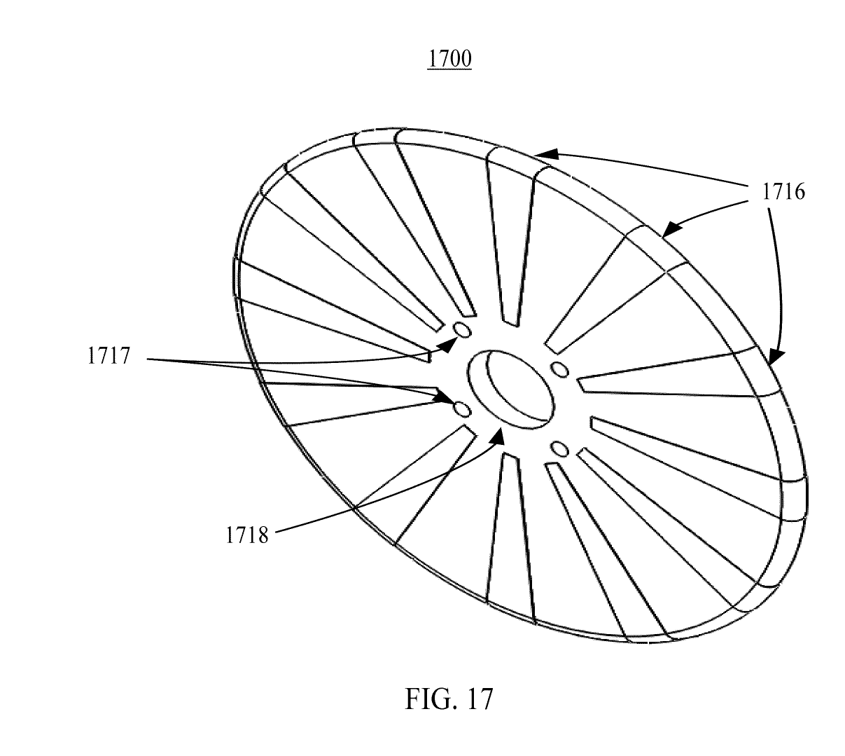

FIG. 17 illustrates a perspective view of an embodiment of a rotor member 1700 in accordance with various aspects as set forth herein. In FIG. 17, the rotor member 1700 may be configured to include a plurality of rotor poles 1716, a plurality of rotor securing mechanisms 1717, and a rotor shaft cutout 1718. Each of the plurality of rotor poles 1716 may be electrically isolated from each other. Each of the plurality of rotor poles 1716 may be on both a front portion and a back portion of the rotor member 1700. Further, each of the plurality of rotor poles 1716 may couple its front portion and its back portion by, for instance, using a conductive plated through hole in the rotor member 1700 or wrapping the conductive layer of the rotor pole around the edge of the rotor member 1700 to connect the front portion and the back portion of the rotor pole. The plurality of rotor securing mechanisms 1717 may be used to secure the rotor member 1700 to a shaft member. The rotor shaft cutout 1718 may be a through hole in the rotor member 1700 used to allow a shaft member to be freely positioned within the rotor member 1700. In FIG. 17, item 1716 is an electrically conductive rotor petal that resides on an electrically insulating substrate 1715. Petals may have surfaces on the front and back of the rotor member 1700 but may be electrically isolated from other petals. The rotor member 1700 may have profiling 1717 and 1718 to permit connection to the motor shaft.

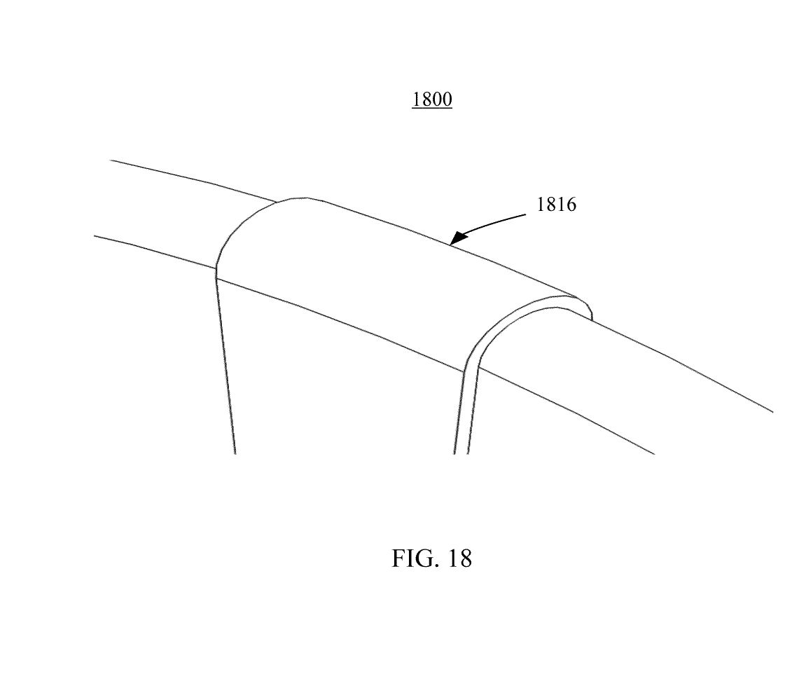

FIG. 18 illustrates a perspective view of a portion of one embodiment of a rotor member 1800 where rotor petal 1816 electrically connects from the front to the back surface of the rotor member in accordance with various aspects as set forth herein. In FIG. 18, a front portion and a back portion of a rotor petal 1816 may be coupled by wrapping the conductive layer of the rotor petal 1816 around the edge of the rotor member 1800. In another embodiment, the rotor petal 1816 may electrically connect to the front and back surfaces using conductively filled holes between the two surfaces.

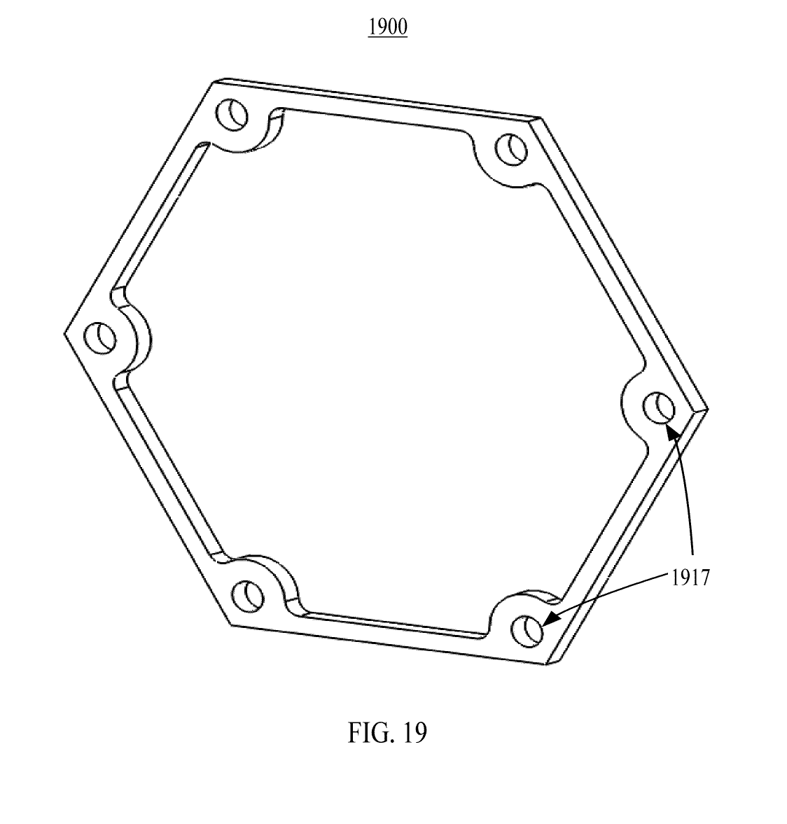

FIG. 19 illustrates a perspective view of one embodiment of a spacer member 1900 in accordance with various aspects as set forth herein. In FIG. 19, each of the plurality of alignment rod securing mechanisms 1917 may be a through hole in the spacer member 1900 used to allow each of a plurality of alignment rods to align the spacer member 1900 with a plurality of stator member assemblies and other spacer members. In another embodiment, each of the plurality of alignment rod securing mechanisms 1917 may be used to align and secure the spacer member 1900. In FIG. 19, item 1917 show alignment holes to improve assembly features of the electrostatic machine.

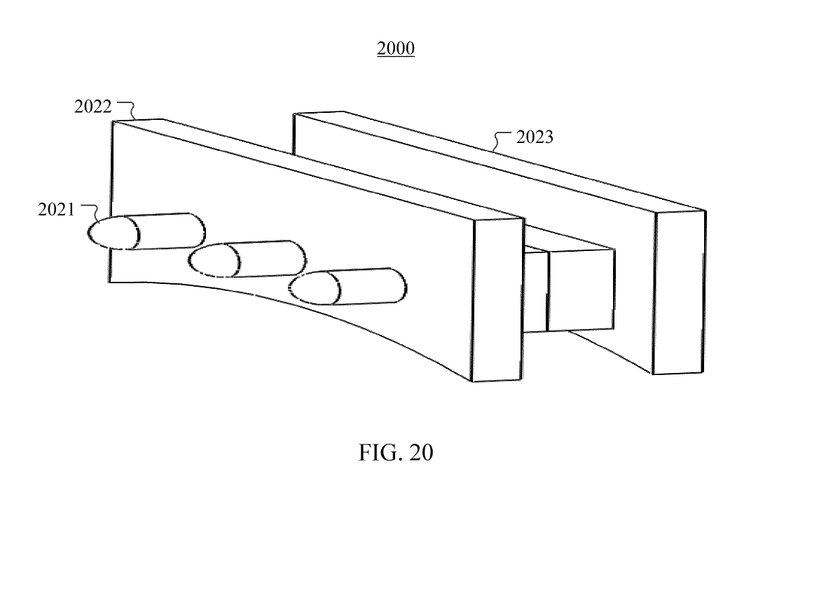

FIG. 20 illustrates a perspective view of one embodiment of a stator modular connector assembly 2000 in accordance with various aspects as set forth herein. In FIG. 20, the stator modular connector assembly 2000 may be configured to include a stator connector 2021, a stator modular connector front housing 2022, and a stator modular connector back housing 2023. Each of the stator connectors 2021 may be used to couple one of a plurality of stator poles to one of a plurality of voltage phases of a voltage source. In one example, the stator connector 2021 may be a receptacle or a plug.

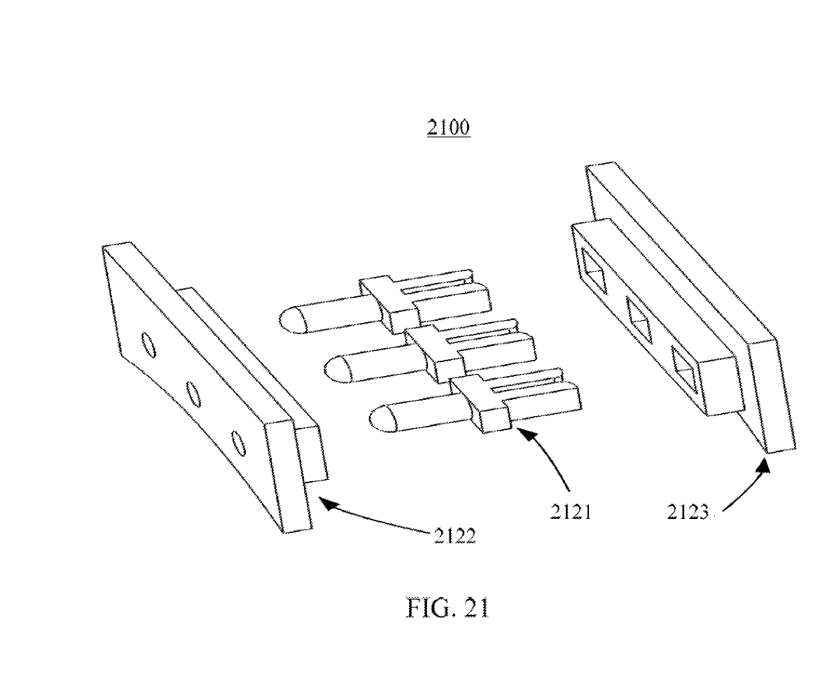

FIG. 21 illustrates an exploded perspective view of another embodiment of a stator modular connector assembly 2100 in accordance with various aspects as set forth herein. In FIG. 21, the stator modular connector assembly 2100 may be configured to include a stator connector 2121, a stator modular connector front housing 2122, and a stator modular connector back housing 2123. Each of the stator connectors 2121 may be used to couple one of a plurality of stator poles to one of a plurality of voltage phases of a voltage source. The stator modular connector assembly 2000 may be composed of a front plate 2122, a back plate 2123 and hermaphroditic electrical connector pin 2121. The stator connector 2121 may be a receptacle or a plug.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

What is claimed is:

1. An operational electrostatic machine (ESM), comprising:
a gap distance and a gap medium pressure product above 100 μm*atm;
outside enclosure housing dimensions having a height, a length and a width that are each greater than one hundred times (100×) the product of the gap distance and the gap medium pressure;
one or more electrically isolated conductive layers that, during operation, facilitate storage of electric charge; and
wherein an electric field created by stored electric charge of a particular polarity passes through surrounding insulative layers, making a path to couple to an electric field of a stored charge of opposite polarity on a contiguous plate; and
wherein, during operation, unaligned conductive layers that are repetitively charged and discharged using appropriate control techniques facilitate production of useful forces.

2. The ESM of claim 1, wherein the ESM is further configured to:
utilize an insulating layer to inhibit breakdown that is formed from an oxide layer on the outer surface of the conductive material.

3. The ESM of claim 1, wherein the ESM is further configured to:
utilize an insulating layer to inhibit breakdown that is a separate insulating layer on a substrate, the layer being applied to the substrate by a method selected from the group consisting of sprayed on, painted on, applied using spin coating, deposited by particle deposition, vapor deposition, deposited by sputtering, e-beam, dip-coating, and otherwise grown onto a substrate.

4. The ESM of claim 1, wherein the ESM is further configured to:
utilize an insulating layer to inhibit breakdown that is a film and is utilized as a conformal layer or nearly conformal layer on the exterior of the conductive surface.

5. The ESM of claim 1, wherein the ESM is further configured to:
utilize a medium that fills the gap and has properties to effectively become an insulator between conductive surfaces and is utilized in combination with an insulating layer applied to the conductive surface.

6. The ESM of claim 1, wherein the ESM is further configured to:
utilize per phase capacitances on the machine of at least one nanofarad (1 nF) and has at least one of a substantially constant force and a substantially constant torque output when operated at constant cyclic motion.

7. The ESM of claim 1 further comprising a specialized coating on at least a portion of the housing that minimizes electromagnetic interference (EMI).

8. The ESM of claim 1, wherein the ESM is further configured to:
maintains, when operating, a substantially constant product of the gap distance and the gap pressure when temperature changes in constituent components occur.

9. The ESM of claim 1, wherein the ESM is rated for at least ten watts (10 W).

10. The ESM of claim 1, wherein the ESM is further configured to:
utilize a substrate to support the conductive layers;
wherein the substrate includes a material selected from the group consisting of glass, ceramic, polymer and composite materials; and
wherein the substrate has a surface roughness and waviness deformations that are less than three hundred and fifty (350) microns in any dimension.

11. The ESM of claim 1, wherein the ESM has surface features that promote one or both of directed electric field patterns and increased leading edge surface length.

12. The ESM of claim 1, wherein the ESM is further configured to:
utilize substrate materials that have been treated using a method that improves a substrate operational performance.

13. The ESM of claim 15, wherein the substrate operational performance is selected from the group consisting of strength, wear and vibration mitigation.

14. The ESM of claim 1, wherein the ESM is further configured to:
measure the gap distance; and
modulate an applied voltage so as to reduce a field breakdown in the gap medium.

15. The ESM of claim 1, wherein the ESM is further configured to:
measure the gap distance; and
modulate an applied voltage so as to improve the force produced by the motor.

16. The ESM of claim 1, wherein the ESM is further configured to:
utilize a medium that fills the gap and has a relative permittivity of at least twenty (20).

17. The ESM of claim 1, wherein the electric field created by the stored charge of the particular polarity passes through surrounding insulative layers having dielectric strength of at least 200V/μm, making a path to connect to the electric field of a stored charge of the opposite polarity on a contiguous plate.

18. The ESM of claim 1, wherein the unaligned conductive layers include a stator and a rotor.

19. The ESM of claim 1, wherein at least one of the insulating layer has a relative permittivity of at least ten (10) and the gap medium has a dielectric strength of at least 3V/μm.

20. The ESM of claim 1, wherein the ESM achieves an efficiency of at least eighty-eight percent (88%).
